(19) United States
(12) Patent Application Publication
(10) Pub. No.: US 2015/0019196 A1
(43) Pub. Date: Jan. 15, 2015

(54) ARITHMETIC UNIT INCLUDING ASIP AND METHOD OF DESIGNING SAME

(71) Applicant: Samsung Electronics Co., Ltd, Gyeonggi-do (KR)

(72) Inventors: Hyun Woo Sim, Gyeonggi-do (KR); Hyuk Min Kwon, Gyeonggi-do (KR); Seung Wook Lee, Seoul (KR); Han Su Cho, Gyeonggi-do (KR)

(21) Appl. No.: 14/376,612

(22) PCT Filed: Jan. 30, 2013
(86) PCT No.: PCT/KR2013/000749

§ 371 Date: Aug. 4, 2014

(30) Foreign Application Priority Data
Feb. 2, 2012 (KR) 10-2012-0010753

(51) Int. Cl. G06F 9/30; G06F 17/50

(52) U.S. Cl. CPC G06F 9/3001; G06F 17/5009
USPC 703/21; 712/221

(57) ABSTRACT

In order to achieve tasks, according to an embodiment of the present invention, an arithmetic unit including one or more ASIPs includes two or more processors, and an execution unit that is connected to the two or more processors and executes instructions received from the processors. According to an embodiment of the present invention, it is possible to provide a low-power, high-integration, high-performance arithmetic unit through resource sharing using the arithmetic unit including the one or more ASIPs, and it is possible to provide a method of designing an arithmetic unit that may be applied to a specific application.

### TECHNICAL FIELD

The present invention relates to an arithmetic device including at least two Application Specific Instruction-set Processors (ASIPs) and method of designing the same. In particular, the present invention relates to the arithmetic device and method of designing the same that is capable of improving the operation efficiency through an execution unit connected to and shared by the plural ASIPs.

### BACKGROUND ART

ASIP is a process optimized for a particular application and includes one or more instructions customized for the application to improve the program execution speed. For example, the ASIP optimized for a baseband modem inevitably has to include the instructions customized for processing Fast Fourier Transform (FFT) operation. If necessary, the program execution speed can be improved using a parallelization technique such as Very Long Instruction Word (VLIW) and Single Instruction Multiple Data (SIMD) independently of the custom instructions.

Recently, many researches are being conducted to implement complicate applications using an arithmetic device including a plurality of ASIPs. Unlike universal Multi-Core Processors, the operations to be executed by the respective ASIPs included in the arithmetic device has to be determined in advance, and based thereon it is possible to implement the arithmetic device including the plural ASIPs finally through a design of adding custom instructions.

FIG. 1 is a diagram illustrating a conventional arithmetic device including a plurality of ASIPs.

Referring to FIG. 1, the conventional arithmetic device includes a first ASIP 100 and a second ASIP 150. Each processor may be an ASIP capable of executing a specific application.

The first ASIP may include a first execution unit 110 and a second execution unit 120 capable of executing instructions executable in a specific application. The second ASIP may include a first execution unit 160 and a third execution unit 170. Although not shown in the drawing, the first and second ASIPs 100 and 150 may include two or more execution units.

The execution units may execute different instructions and, in the case of executing the same instruction, may differ in processing speed from each other.

In the case of the conventional arithmetic device having plural ASIPs, the ASIPs have respective execution units as described above and thus the executions units responsible for the same role in different ASIPs cause resource waste.

As the scale of the processors increases in the arithmetic device, there is a need of optimization for reduction of the occupation area and power consumption and performance enhancement through resource sharing.

### DISCLOSURE OF INVENTION

### Technical Problem

The present invention has been conceived to solve the above problem and aims to provide a low power high performance arithmetic device and design method thereof through resource sharing in the arithmetic device including a plurality of ASIPs. Also, the present invention aims to provide an arithmetic device and design method thereof which is capable of utilizing resources efficiently through ASIPS sharing by changing the arrangement of ASIPs according to the instruction to be executed by the arithmetic device.

### Solution to Problem

In accordance with an aspect of the present invention, an arithmetic device having at least one ASIP includes at least two processors and execution units which are connected to the at least two processors and executes instructions received from the at least two processors.

In accordance with another aspect of the present invention, a method for designing an arithmetic device including at least two processors using an Instruction Set Simulator (ISS) includes executing a target application on a simulation arithmetic device including at least two processors, measuring use frequency of an instruction used by the target application, selecting execution units to be shared by the processors for executing the instruction based on the use frequency of the instruction, and determining arrangement of the shared execution unit according to the use frequency.

### Advantageous Effects of Invention

The present invention is advantageous in terms of providing an arithmetic device having one or more ASIPs that is capable of implementing low-power high-density high-performance through resource sharing and a method of designing the arithmetic device capable of applying to specific application.

### BRIEF DESCRIPTION OF DRAWINGS

FIG. 1 is a diagram illustrating a conventional arithmetic device including a plurality of ASIPs.

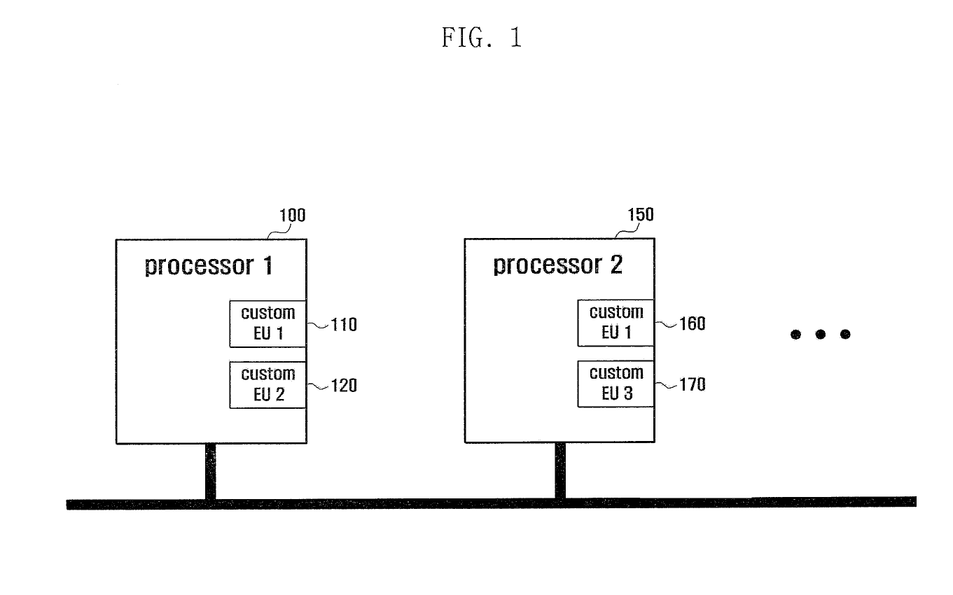

FIG. 2 is a diagram illustrating an arithmetic device including a plurality of ASIPs according to an embodiment of the present invention.

FIG. 3 is a diagram illustrating an arithmetic device including a plurality of ASIPs and a plurality of execution units according to another embodiment of the present invention.

FIG. 4 is a diagram illustrating signal exchange between ASIPs and an execution unit according to an embodiment of the present invention.

FIG. 5 is a flowchart illustrating a method of designing an arithmetic device including a plurality of ASIPs according to an embodiment of the present invention.

### MODE FOR THE INVENTION

Exemplary embodiments of the present invention are described with reference to the accompanying drawings in detail.

Detailed description of well-known functions and structures incorporated herein may be omitted to avoid obscuring the subject matter of the present invention. This aims to omit unnecessary description so as to make the subject matter of the present invention clear.

For the same reason, some of elements are exaggerated, omitted or simplified in the drawings and the elements may have sizes and/or shapes different from those shown in drawings, in practice. The same reference numbers are used throughout the drawings to refer to the same or like parts.

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

In this specification, ASIP denotes a type of processor and is referred to an exemplary processor in the embodiments. According to an embodiment, the ASIP may be a physical or logical structure inside the arithmetic device.

The arithmetic devices including ASIPs and design methods thereof according to the embodiments of the present invention are described hereinafter with reference to accompanying drawings.

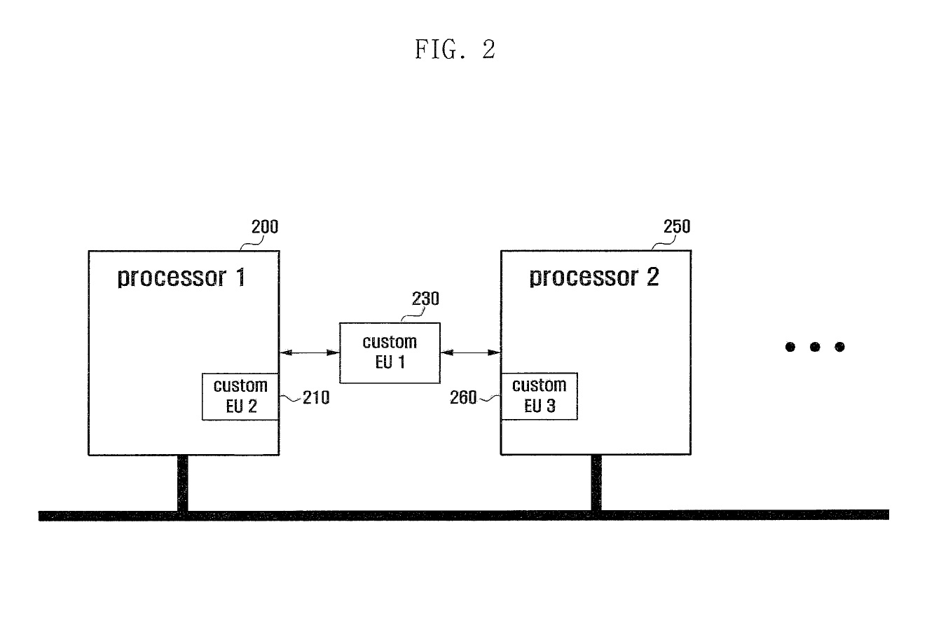

FIG. 2 is a diagram illustrating an arithmetic device including a plurality of ASIPs according to an embodiment of the present invention.

Referring to FIG. 2, the arithmetic device may include a first ASIP 200 and a second ASIP 250 that are capable of instructions of specific applications.

The arithmetic device may further include a first Execution Unit (EU) 230 connected to the first and second ASIPs 200 and 250 and capable of executing an instruction set. The first execution unit 230 may receive a request necessary for the instruction from both the first and second ASIPs 200 and 250. The first execution unit 230 also may receive input data necessary for the instruction, execute operation on the instruction based on the input data, and transmit the output data including operation result to the ASIP.

By sharing the execution units among the plural ASIPs in this way, it is possible to reduce resource waste as compared to the case of arranging the execution units executing the same instruction independently. It is also possible to improve integration density and performance. The execution unit may be a logical or physical module depending on the embodiment. For example, the execution unit may be an operation-specific processor.

The first execution unit 230 may connect to a plurality of ASIPs through dedicated interfaces. By connecting the first execution unit 230 to plural ASIPs through dedicated interfaces, it is possible to expect reducing data input/output delay and improving operation speed as compared to the case of connection through a bus.

The first ASIP 200 may include the second execution unit 210. In an embodiment, the second execution unit 210 executes the instructions executable only in the first ASIP 200. By arranging the second execution unit 210, which is used frequently in the first ASIP 200 but not used in other ASIPs, inside the first ASIP 200, it is possible to avoid performance degradation caused by collision among the processors. How to determine the execution units to be shared and the operations of the execution units in collision between processors are described later.

The second ASIP 250 may include the third execution unit 260. The third execution unit 260 is the execution unit executing the instructions capable of being executed only in the second ASIP 250. Depending on the embodiment, each ASIP may further include execution units capable of performing operations.

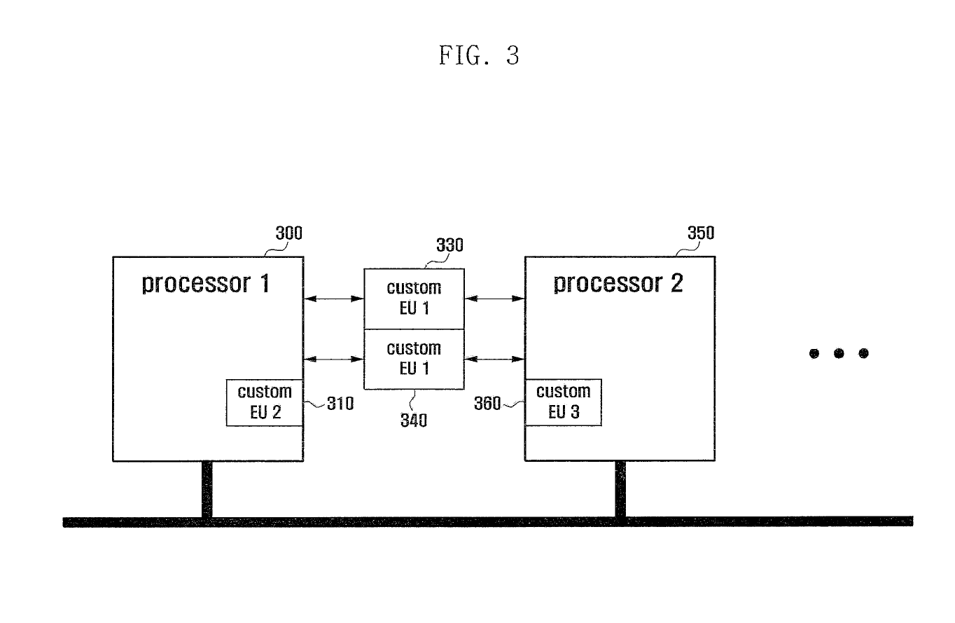

FIG. 3 is a diagram illustrating an arithmetic device including a plurality of ASIPs and a plurality of execution units according to another embodiment of the present invention.

Referring to FIG. 3, the arithmetic device may include a first ASIP 300 and a second ASIP 350 capable of executing an instruction set of a specific application. The first and second ASIPs 300 and 350 may execute the instruction sets necessary for executing specific applications respectively. The instructions may be executed by the corresponding execution units.

The arithmetic device may include first execution units 330 and 340 connected to the first and second ASIPs 300 and 350. The first execution units 330 and 340 may execute the same instruction and, in this embodiment, the two first execution units 330 and 340 are connected to the first and second ASIPs 300 and 350. This is a structure capable of being used in the arithmetic device having the instructions executed frequently by the first execution units 330 and 340.

By connecting the first execution units 330 and 340 to the first and second ASIPs 300 and 350 in parallel in this way, both the ASIPs allow the first execution units 330 and 340 to execute the instructions that are occurring in overlapped time durations so as to avoid reduction of execution speed. By taking the parallel structure, it is possible to accomplish the parallel processing operation such as Single Instruction Multiple Data (SIMD) operation, resulting in improvement of efficiency of the arithmetic device. According to an embodiment, it is possible to perform scheduling so as to use the execution units 330 and 340 in the optimized way.

The first ASIP 300 may include a second execution unit 310 capable of executing specific instructions. Also, the second ASIP 350 may include a third execution unit 360 capable of executing other specific instructions. In an embodiment, the second execution unit 310 may be the execution unit for executing the instructions executable only in the first ASIP 300. Also, the third execution unit 360 may be the execution unit for executing the instructions executable only in the second ASIP 350.

According to an embodiment, the number of the first execution units may be determined differently depending on the use frequency of the instructions, which is executable by the first execution units 330 and 340, are executed in the ASIPs 300 and 350.

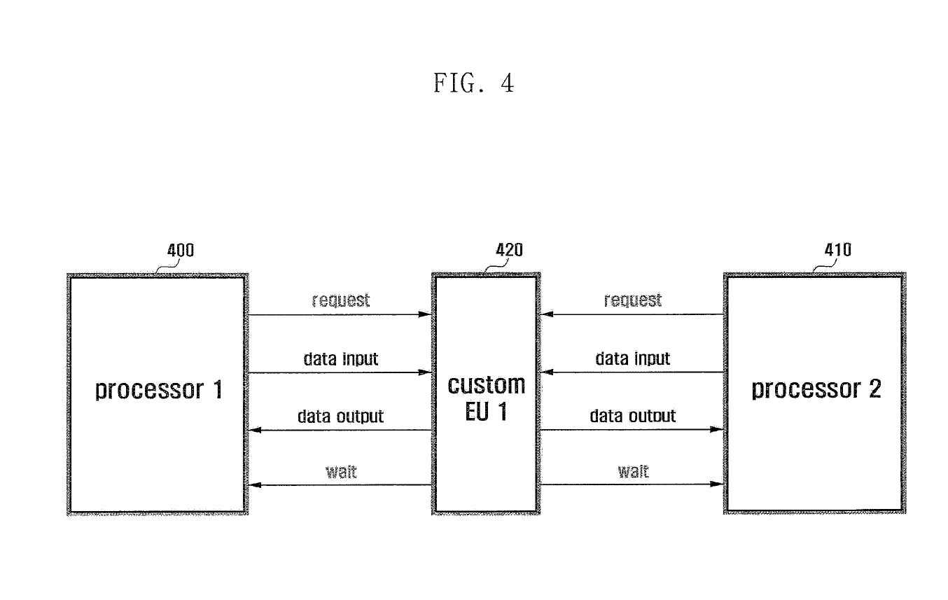

FIG. 4 is a diagram illustrating signal exchange between ASIPs and an execution unit according to an embodiment of the present invention.

Referring to FIG. 4, a first ASIP 400 and a second ASIP 410 that are capable of executing instruction sets of specific applications share a first execution unit 420 capable of executing the specific instructions. The first execution unit 420 is connected to the first and second ASIPs 400 and 410 to execute the instructions based on the signals transferred by the respective ASIPs.

The instruction execution procedure of the first execution 420 is described as an example.

The first execution unit 420 may receive a request for executing an instruction from a specific ASIP. The request signal may be of being used to check whether the first execution unit 420 is executing an operation currently. If the first execution unit 420 is executing an operation when the request signal is received from the ASIP, it may send the corresponding ASIP a wait signal. Through this process, it is possible to avoid collision of the instruction execution request signals received simultaneously. If the wait signal is received, this means that the first execution unit 420 is executing the operation corresponding to the request signal transmitted by another ASIP and thus the ASIP may send the first execution unit 420 the request signal periodically. By transmitting the request signal periodically, it is possible to check the time when the first execution unit 420 ends the ongoing operation.

If the first execution unit 420 is not execution any operation when the request signal is received from the specific ASIP, it may receive input data from the specific ASIP and executes the instruction based on the input data to transmit output data to the specific ASIP. Since the same instruction set can be used even when plural ASIPs share the execution unit, there is no need of changing the structure of the compiler. Accordingly, it is possible to improve the integration density and execution performance of the arithmetic device by sharing the execution unit.

The first execution unit 420 may receive the request signals from a plurality of ASIPs in predetermined time duration. In this case, the first execution unit 420 has to select one of the ASIPs to reply in response to the request signals. The ASIP selection may be perform through a predetermined scheduling method, and the first execution unit 420 may transmit the wait signal to the ASIPs that are not selected. Examples of the scheduling method include First Come First Service (FCFS), Priority, Deadline, Round Robin, Shortest Remaining Time (SRT), Highest Response Ratio Next (HRN), multi-step queue, and multi-step feedback queue. The scheduling technique may be determined selectively depending on the characteristics of the instruction and application.

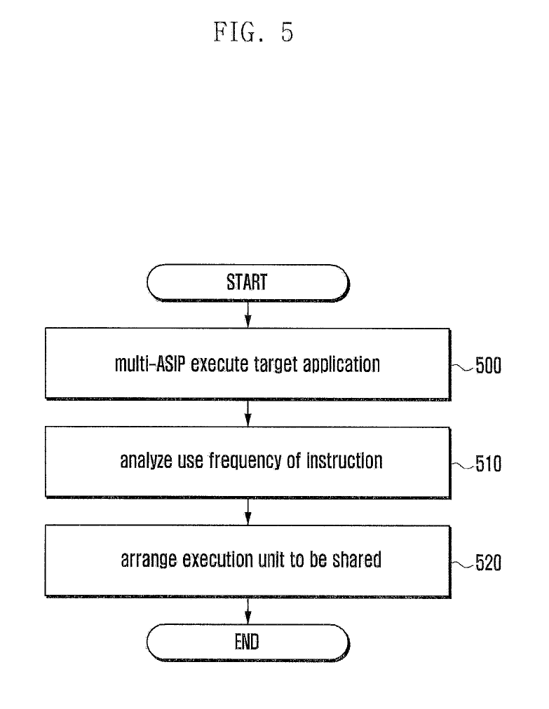

FIG. 5 is a flowchart illustrating a method of designing an arithmetic device including a plurality of ASIPs according to an embodiment of the present invention.

Referring to FIG. 5, an Instruction Set Simulator (ISS) executes a target application in the arithmetic device including a plurality of ASIPs at step 500. The ISS may check the type of the instruction, a number of execution times, data flow according to the instruction.

The arithmetic device including the plural ASIPs may be the arithmetic device configured previously and may be referred to as simulation arithmetic device. Because step 500 is the step of checking the occurrence frequencies of the instruction executed by the target application, the simulation arithmetic device may be made up of the plural ASIPs without inclusion of any execution unit shared among the ASIPs.

The ISS may analyze the use frequency of the instruction executed by the simulation arithmetic device at step 510. There is no big difference in types of the instructions used in executing the target application. The ISS analyzes the use frequency of the instruction used in various environments. In the way, the ISS may check the use frequency and occurrence number of a specific instruction to determine whether to share the execution unit for executing the corresponding instruction afterward. Since there is a plurality ASIPs, it is possible to analyze the types of the instructions and number of occurrences of the instructions executed per ASIP. In this case, if an instruction is used only in a specific ASIP, it is not necessary to share the execution unit for the corresponding instruction.

At step 520, the execution unit to be shared may be arranged based on the analysis result obtained at step 510. The execution unit to be shared may be determined in various ways.

In the case of the execution unit which is used by the plural ASIPs simultaneously but infrequently, it is preferred to connect the execution unit to the ASIPs so as to be shared. Through this design, it is possible to avoid the resource waste caused by designing the plural ASIPs to have respective execution units.

In another embodiment, in the case of the execution unit which is used by the plural ASIPs simultaneously and frequently, it is preferred to install the execution unit per ASIP. According to an embodiment, when the execution unit is used by the ASIPs equal to or greater in number than a predetermined value simultaneously or the number of the ASIPs calling the execution unit simultaneously is greater than a predetermined value, the number of execution units may be adjusted. In another embodiment, it is possible to increase the number of execution units used frequently and shared by the ASIPs.

In another embodiment, in the case of the execution unit used by the plural ASIPs simultaneously and frequently, it is possible to share a plurality of execution units capable of executing the same instruction among the ASIPs. This is advantageous in terms of parallel processing.

The determination of the number of execution units to be shared according to the use frequency and number of ASIPs may be determined based on a predetermined value. The predetermined value is of increasing the number of execution units to be shared when the shared execution unit use frequency of the ASIPs is equal to or greater than a predetermined value and thus may be adjusted.

It is to be appreciated that those skilled in the art can change or modify the embodiments without departing the technical concept of this invention. Accordingly, it should be understood that above-described embodiments are essentially for illustrative purpose only but not in any way for restriction thereto. Thus the scope of the invention should be determined by the appended claims and their legal equivalents rather than the specification, and various alterations and modifications within the definition and scope of the claims are included in the claims.

Although preferred embodiments of the invention have been described using specific terms, the specification and drawings are to be regarded in an illustrative rather than a restrictive sense in order to help understand the present invention. It is obvious to those skilled in the art that various modifications and changes can be made thereto without departing from the broader spirit and scope of the invention.

1. An arithmetic device having at least two processors, the device comprising:
execution units which are connected to the at least two processors and configured to execute instructions received from the at least two processors.

2. The device of claim 1, wherein the execution units are at least two in and connected to the at least two processors respectively.

3. The device of claim 2, wherein the at least two execution units are configured to perform a Single Instruction Multiple Data (SIMD) operation process on data received from the at least two processors.

4. The device of claim 1, wherein the execution unit is configured to receive a request signal for executing an instruction from one or more of the at least two processors and transmit, while another operation is executing when the request signal is received, a wait signal to the processor transmitting the request signal.

5. The device of claim 4, wherein the processor which receives the wait signal from the execution unit is configured to transmit the request signal to the execution unit repeatedly at an interval.

6. The device of claim 4, wherein the processor is configured to transmit, when no wait signal is received from the execution unit, an input data to the execution unit and receive an output data generated by the execution unit based on the input data.

7. The device of claim 4, wherein the execution unit is configured to determine, when a plurality of request signals are received from the at least two processors in a predetermined time duration, a processor of the at least two processors to which the wait signal is transmitted using a predetermined scheduling method.

8. The device of claim 7, wherein the scheduling method is one of First Come First Service (FCFS), Priority, Deadline, Round Robin, Shortest Remaining Time (SRT), Highest Response Ratio Next (HRN), multi-step queue, and multi-step feedback queue.

9. The device of claim 1, wherein the execution units are connected to the processors through dedicated interfaces.

10. A method for designing an arithmetic device including at least two processors using an Instruction Set Simulator (ISS), the method comprising:
executing a target application on a simulation arithmetic device including at least two processors;
measuring use frequency of an instruction used by the target application;
selecting execution units to be shared by the at least two processors for executing the instruction based on the use frequency of the instruction; and
determining arrangement of the shared execution unit according to the use frequency.

11. The method of claim 10, wherein selecting the execution units to be shared comprises:
counting a number of processors which uses the instruction; and
measuring a number of use times of the instruction per processor.

12. The method of claim 11, wherein selecting the execution units to be shared comprises configuring, when a number of processors using the instruction is equal to or greater than a predetermined value and the number of use times of the instruction per processor is equal to or less than a predetermined value, the corresponding unit as the shared execution unit.

13. The method of claim 11, wherein determining the arrangement of the shared execution unit comprises increasing, when a number of use times of the instruction per processor is equal to or greater than a predetermined value, a number of the shared execution units to a predetermined value.

14. The method of claim 10, further comprising receiving, by the shared execution unit, a request signal for executing the instruction from at least one processor, and transmitting, when another operation is being is executed when the request signal is received, a wait signal to the processor which has transmitted the request signal.

15. The method of claim 14, further comprising determining, by the shared execution unit, a processor to which the wait signal is transmitted using a predetermined scheduling method.

16. The device of claim 1, wherein the execution units are configured to execute the same instructions.

17. The method of claim 10, wherein the execution units execute the same instruction.

18. The device of claim 1, wherein the execution units are connected to the at least two processors in a parallel configuration.

19. The method of claim 10, wherein the execution units are connected to the at least two processors in a parallel configuration.

20. The device of claim 1, wherein the at least two processors are Application Specific Instruction-set Processors (ASIPs).
